(19) United States
(12) Patent Application Publication
(10) Pub. No.: US 2018/0059483 A1
(43) Pub. Date: Mar. 1, 2018

(54) SUPPORT STRUCTURE, DIRECT-TYPE BACKLIGHT, BACK PLATE AND DISPLAY DEVICE

(71) Applicant: Boe Technology Group Co., Ltd., Beijing (CN)

(72) Inventors: Yongda MA, Beijing (CN); Jian XU, Beijing (CN); Yong HU, Beijing (CN)

(21) Appl. No.: 15/526,807

(22) PCT Filed: May 13, 2016
(86) PCT No.: PCT/CN16/81974

§ 371 Date: May 15, 2017

(30) Foreign Application Priority Data
Feb. 15, 2016 (CN) 201620120923.5

(51) Int. Cl. G02F 1/1335; F16B 5/06; F21V 17/00

(52) U.S. Cl. CPC G02F 1/133606; G02F 1/133608; G02F 2001/133314; F21V 17/00; F16B 5/065

(57) ABSTRACT

A support structure, a back plate, a direct-type backlight and a display device pertaining to the field of display technology are provided. The support structure includes a batten which comprises an upper surface and a lower surface, a support column arranged on the upper surface, and at least one clamping hook which comprises a connection part and a strip part, wherein the connection part connects the strip part and the lower surface, and the strip part is arranged with a protrusion towards the lower surface.

### RELATED APPLICATIONS

The present application is the U.S. national phase entry of PCT/CN2016/081974, with an international filing date of May 15, 2016, which claims the benefit of Chinese Patent Application No. 201620120923.5 filed on Feb. 15, 2016, the entire disclosures of which are incorporated herein by reference.

### TECHNICAL FIELD

The disclosure pertains to the field of display technology, and in particular, to a support structure, a back plate, a direct-type backlight and a display device.

### BACKGROUND

Liquid crystal display devices have already been widely applied in electronic information products such as mobile phones, notebooks, displays, etc. An existing liquid crystal display device primarily comprises a liquid crystal display panel and a backlight module which provides the liquid crystal display panel with a surface light source.

### SUMMARY

An embodiment of the disclosure employs the following technical solution: a support structure comprising: a batten which comprises an upper surface and a lower surface, a support column arranged on the upper surface, and at least one clamping hook which comprises a connection part and a strip part, wherein the connection part connects the strip part and the lower surface, and the strip part is arranged with a protrusion towards the lower surface.

Optionally, the support structure comprises at least two clamping hooks.

Optionally, the strip parts of the at least two clamping hooks are arranged in parallel to each other.

Optionally, the support structure comprises one clamping hook.

Optionally, the connection part of the clamping hook is arranged at the center of the strip part, and one said protrusion is arranged at each of two ends of the strip part, respectively.

Optionally, the clamping hook may rotate around an axis perpendicular to the lower surface relative to the batten.

Optionally, the support column comprises a main support column and an auxiliary support column, and height of the main support column is greater than that of the auxiliary support column in a direction perpendicular to the upper surface.

An embodiment of the disclosure further provides a back plate comprising mounting holes for being passed through by the clamping hooks of the above described support structures and locking holes for engaging the protrusions.

Optionally, the mounting holes are uniformly distributed on the back plate.

An embodiment of the disclosure further provides a direct-type backlight comprising a diffusing plate and the above described back plate which are oppositely arranged, and a plurality of support structures as described above located between the back plate and the diffusing plate.

Optionally, between the batten and the back plate is arranged a reflective sheet which is arranged in parallel to the lower surface, and the reflective sheet is provided with a mounting hole corresponding to the clamping hook.

Optionally, between the back plate and the diffusing plate are further comprised a plurality of light sources, and the support structures do not coincide with the projections of the light sources in a direction perpendicular to the diffusing plate.

An embodiment of the disclosure further provides a display device comprising a direct-type backlight as described above.

In the support structure of the embodiments of the disclosure, the support column is employed to support the diffusing plate, the clamping hook is employed to pass through the mounting hole on the back plate, and then the support structure is moved to cause the locking hole to engage with the protrusion and accomplish the engagement and locking operation. The support structure is used for a direct-type backlight, and at the time of overhaul and alternatively maintenance, it suffices to reversely move the support structure. The direct-type backlight of the embodiments of the disclosure is suitable for various display devices.

### BRIEF DESCRIPTION OF THE DRAWINGS

FIG. 1 is a cross section structure diagram of an existing direct-type backlight.

FIG. 2 is a structure diagram of a support structure provided by an embodiment of the disclosure.

FIG. 3 is another structure diagram of a support structure provided by embodiments of the disclosure.

FIG. 4 is a structure diagram of the use of the support structure provided by embodiments of the disclosure in a direct-type backlight.

FIG. 5 is a schematic top view of the use of the support structure provided by embodiments of the disclosure in a direct-type backlight.

FIG. 6 is a structure diagram of a back plate of a direct-type backlight provided by embodiments of the disclosure.

FIG. 7 is another structure diagram of a back plate of a direct-type backlight provided by embodiments of the disclosure.

### DETAILED DESCRIPTION

As shown in FIG. 1, generally, a direct-type backlight comprises a back plate 2, a light source 4, a plurality of support structures 30 and a diffusing plate 1, wherein the back plate 2 is arranged opposite to the diffusing plate 1, the support structures 30 are arranged between the back plate 2 and the diffusing plate 1, a display panel 5 is placed on the diffusing plate 1 of the direct-type backlight. The light emitted by the light source 4 is provided to the display panel 5 through the diffusing plate 1. With the gradual increase of the size of the direct-type liquid crystal display device, to prevent the diffusing plate 1 and the display panel 5 from bending and sagging due to the effect of their own gravities, generally, a plurality of support structures 30 will be disposed between the back plate 2 and the diffusing plate 1 for supporting the diffusing plate 1 and the display panel 5, thereby obtaining a better display effect.

The inventors have found that at least the following problem exists in the prior art: the support structures 30 are mostly directly glued to and alternatively nailed to the back plate 2, and in the process of backlight maintenance, it is difficult to disassemble the support structures 30 nailed to the back plate 2.

In the following embodiments of the disclosure will be further described in detail in conjunction with the drawings and specific implementations, in order to make the person having ordinary skills in the art better understand the technical solutions of the embodiments of the disclosure.

Reference signs: 1—Diffusing plate, 2—Back plate, 201—Mounting hole, 202—Locking hole, 30—Support structure, 301—Main support column, 302—Auxiliary support column, 303—Batten, 304—Clamping hook, 3041—Connection part, 3042—Strip part, 3043—Protrusion, 4—Light source, 5—Display panel, 6—Reflective sheet.

An embodiment of the disclosure provides a support structure comprising: a batten which comprises an upper surface and a lower surface, a support column arranged on the upper surface, and at least one clamping hook which comprises a connection part and a strip part, wherein the connection part connects the strip part and the lower surface, and the strip part is arranged with a protrusion towards the lower surface.

In the support structure of the embodiment, the support column is employed to support the diffusing plate, the clamping hook is employed to pass through a mounting hole on a back plate, and then the support structure is moved to cause a locking hole to engage with the protrusion and accomplish the engagement and locking operation. The support structure is used for a direct-type backlight, and at the time of overhaul and alternatively maintenance, it suffices to reversely move the support structure. The direct-type backlight of the embodiments of the disclosure is suitable for various display devices.

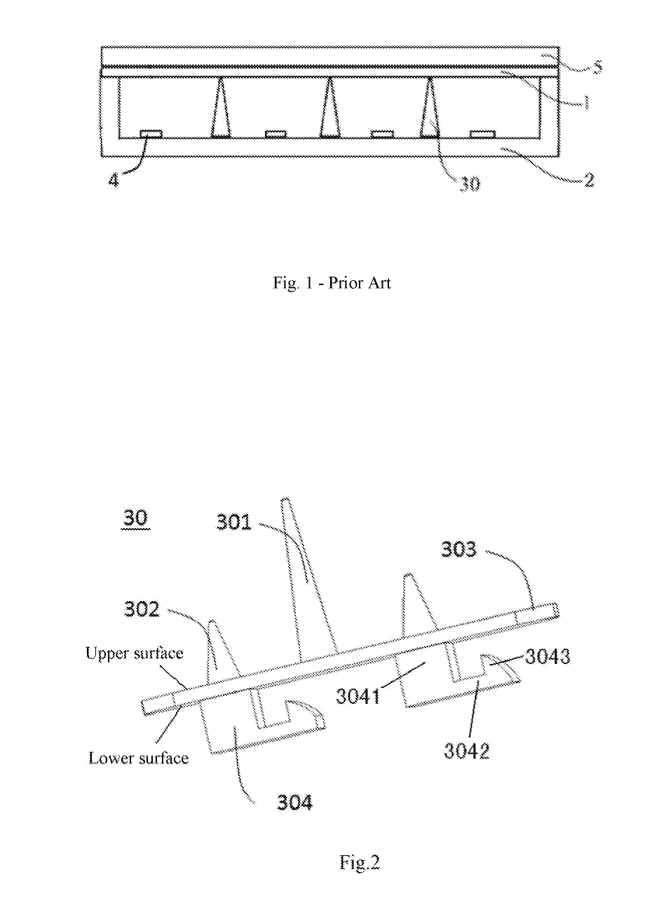

In an embodiment, there is provided a support structure 30, as shown in FIGS. 2-7, comprising: a batten 303 comprising an upper surface which is closer to a display screen and a lower surface which is closer to a back plate after being mounted, the lower surface being pressed against a face of the back plate 2 closer to a diffusing plate 1, a support column arranged on the upper surface of the batten 303, i.e., a face of the batten closer to the diffusing plate 1, for supporting the diffusing plate 1, and at least one clamping hook 304 which comprises a connection part 3041 and a strip part 3042, wherein the connection part 3041 connects the strip part 3042 and the lower surface, and the strip part 3042 is arranged with a protrusion 3043 towards the lower surface.

In the support structure 30 of the embodiment, the support column is employed to support the diffusing plate 1, the clamping hook 304 is employed to pass through a mounting hole 201 on the back plate 2, and then the support structure 30 is moved to cause a locking hole 202 to engage with the protrusion 3043 and accomplish the engagement and locking operation. The support structure 30 is used for a direct-type backlight, and at the time of overhaul and alternatively maintenance, it suffices to reversely move the support structure 30. The direct-type backlight of the embodiments of the disclosure is suitable for various display devices.

Optionally, the support structure 30 comprises at least two clamping hooks 304, as shown in FIG. 2.

Generally, the batten 303 is designed to be long strip shaped. Since two points may fix a straight line, that two clamping hooks 304 are arranged on one batten 303 may substantially fix the support structure 30.

Optionally, the strip parts 3042 of the at least two clamping hooks 304 are arranged in parallel to each other, as shown in FIG. 2.

The use of the strip parts 3042 arranged in parallel to each other may facilitate installation and disassembly.

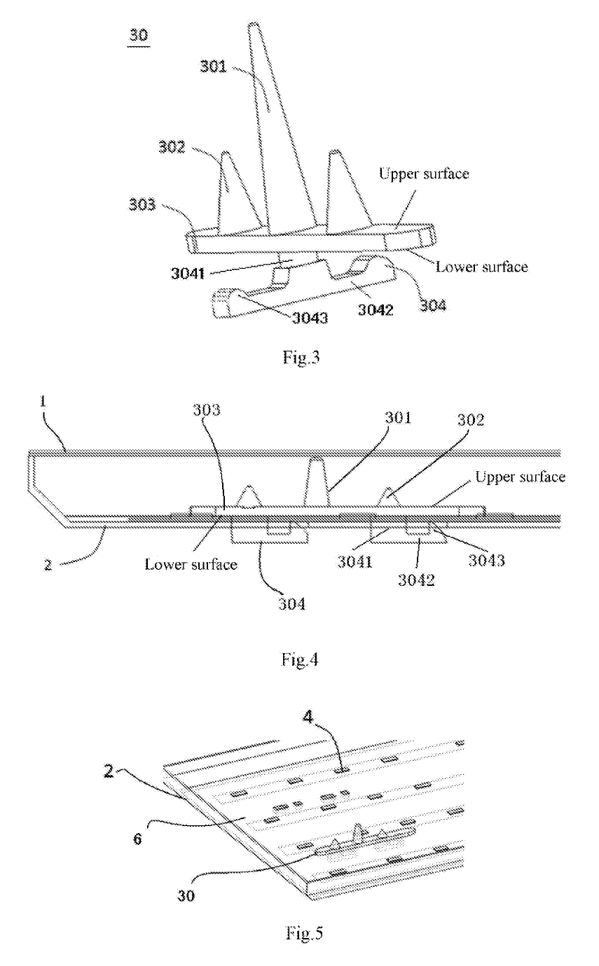

Optionally, the support structure 30 comprises one clamping hook 304, as shown in FIG. 3.

After the single clamping hook 304 is inserted into a mounting hole, the support structure 30 is rotated around an axis perpendicular to the lower surface, and then the protrusion 3043 of the clamping hook 304 may engage with a locking hole.

Optionally, the connection part 3041 of the clamping hook 304 is arranged at the center of the strip part 3042, and one said protrusion 3043 is arranged at each of two ends of the strip part 3042, respectively. In this way, the support structure 30 may be more securely mounted on the back plate.

Optionally, the clamping hook 304 may rotate around an axis perpendicular to the lower surface relative to the batten 303. Although the location of the clamping hook 304 shown in FIG. 3 corresponds to the support column 301, it will be appreciated by the person having ordinary skills in the art that when only one clamping hook 304 is used, the clamping hook 304 may be arranged at any location of the lower surface. After the clamping hook 304 passes through the mounting hole 201 and rotates a certain angle, the protrusion engages with the locking hole 202.

Optionally, the support column comprises a main support column 301 and an auxiliary support column 302, and height of the main support column 301 is greater than that of the auxiliary support column 302 in a direction perpendicular to the upper surface. That is, the structures of the main support column 301 and the auxiliary support column 302 are similar, the height of the main support column 301 is somewhat larger than that of the auxiliary support column 302, and the arrangement of the auxiliary support column 302 facilitates the mounting and disassembling operations.

In some embodiments, as shown in FIG. 2 and FIG. 3, the support structure 30 is integrally formed. When in use, the support structure 30 is moved laterally and alternatively the support structure 30 is rotated, to cause the locking hole 202 to engage with the protrusion and accomplish the engagement and locking operation. Schematic diagrams of the use of the support structure in a direct-type backlight are as shown in FIG. 4 and FIG. 5. In some embodiments, the clamping hook 304 may rotate with respect to the batten 303. When in use, the clamping hook 304 is rotated to a location where it is parallel to the batten 303, and mounted onto a back plate 2 as shown in FIG. 7, and then the clamping hook 304 is again rotated to make the clamping hook 304 be at a certain angle with the batten 303, which thereby causes the locking hole 202 to engage with the protrusion and accomplishes the engagement and locking operation.

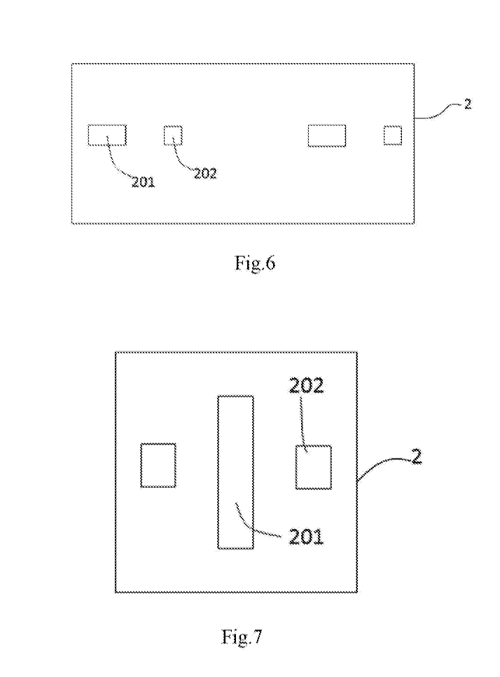

In an embodiment, there is provided a back plate 2, as shown in FIG. 6 and FIG. 7, comprising mounting holes 201 for being passed through by the clamping hooks 304 of the support structures 30 and locking holes 202 for engaging the protrusions, wherein the support structures 30 are the support structures 30 of embodiment 2.

That is, the back plate 2 in FIG. 6 corresponds to the clamping hook 304 in FIG. 2, and the back plate 2 in FIG. 7 corresponds to the clamping hook 304 in FIG. 3. The integrally formed clamping hook 304 in FIG. 2 passes through the mounting hole 201 on the back plate 2 in FIG. 6, and then the clamping hook 304 is moved in parallel toward the right to cause the locking hole 202 to engage with the protrusion and accomplish the engagement and locking operation. When it comes to maintenance and disassembly, the clamping hook 304 is moved in parallel toward the left, and it suffices that the protrusion departs from the locking hole 202. The clamping hook 304 in FIG. 3 may rotate with respect to the batten 303. When in use, the clamping hook 304 is rotated to a location where it is parallel to the batten 303, and passes through the mounting hole 201 in FIG. 7, and then the clamping hook 304 is rotated to make the clamping hook 304 be at a certain angle with the batten 303 and make the clamping hook 304 rotate to the locking hole 202 in FIG. 7, which thereby causes the locking hole 202 to engage with the protrusion and accomplishes the engagement and locking operation. When it comes to maintenance and disassembly, the clamping hook 304 is rotated reversely, such that the protrusion departs from the locking hole 202.

Optionally, the mounting holes 201 are uniformly distributed on the back plate 2.

That is, a plurality of support structures 30 may be arranged between the back plate 2 and the diffusing plate 1, wherein the support structures 30 are uniformly distributed between the back plate 2 and the diffusing plate 1, so as to provide the display panel 5 with uniform support force.

In an embodiment, there is provided a direct-type backlight, as shown in FIGS. 2-7, comprising a diffusing plate 1 and a back plate 2 in embodiment 3 which are oppositely arranged, and a plurality of support structures as described in embodiment 2 located between the back plate 2 and the diffusing plate 1.

For a direct-type backlight which uses the above described support structure 30, at the time of overhaul and alternatively maintenance, it suffices to reversely move the support structure 30. The direct-type backlight of the embodiments of the disclosure is suitable for various display devices.

Optionally, between the back plate 2 and the diffusing plate 1 are further comprised a plurality of light sources 4, and the support structures 30 do not coincide with the projections of the light sources 4 in a direction perpendicular to the diffusing plate 1.

That is to say, the support structures 30 dodge the light sources 4, and the support structures 30 are mounted at locations where the light sources 4 are not arranged on the back plate 2.

Optionally, between the batten 303 and the back plate 2 is arranged a reflective sheet 6 which is arranged in parallel to the lower surface, and the reflective sheet 6 is provided with a mounting hole 201 corresponding to the clamping hook 304 for being passed through by the clamping hook 304.

In other words, between the batten 303 and the back plate 2 is arranged a reflective sheet 6, and the role of the reflective sheet 6 is to improve the utilization of the light source 4. In order that the clamping hook 304 passes through the reflective sheet 6 and in turn passes through the back plate 2, a mounting hole 201 is also arranged on the reflective sheet 6 accordingly.

In an embodiment, there is provided a display device comprising any of the direct-type backlights described above. The display device may be any product and alternatively any component with the display function, such as a liquid crystal display panel, an electronic paper, a mobile phone, a tablet computer, a television set, a display, a notebook computer, a digital photo frame, a navigator, etc.

Clearly, many changes may be made to the specific implementations of the above described individual embodiments. For example, the particular sizes of the batten, the support structure and the clamping hook may be adjusted according to the size of the direct-type backlight, and the number of the support structures arranged between the back plate and the diffusing plate may be varied according to the specific model.

It may be appreciated that, the above implementations are just exemplary implementations employed for the purpose of illustrating the principles of the invention, however, the invention is not limited thereto. For those people having ordinary skills in the art, various variations and improvements may be made without departing from the spirit and substance of the invention, and these variations and improvements are also construed as falling within the protection scope of the invention.

1. A support structure comprising:
a batten comprising an upper surface and a lower surface,
a support column arranged on the upper surface, and
at least one clamping hook comprising a connection part and a strip part, wherein the connection part is configured to connect the strip part and the lower surface, and the strip part is arranged with a protrusion towards the lower surface.

2. The support structure as claimed in claim 1, wherein the support structure comprises at least two clamping hooks.

3. The support structure as claimed in claim 2, wherein the strip parts of the at least two clamping hooks are arranged in parallel to each other.

4. The support structure as claimed in claim 1, wherein the support structure comprises one clamping hook.

5. The support structure as claimed in claim 4, wherein the connection part of the clamping hook is arranged at the center of the strip part, and one said protrusion is arranged at each of two ends of the strip part, respectively.

6. The support structure as claimed in claim 4, wherein the clamping hook rotates around an axis perpendicular to the lower surface relative to the batten.

7. The support structure as claimed in claim 1, wherein the support column comprises a main support column and an auxiliary support column, and height of the main support column is greater than that of the auxiliary support column in a direction perpendicular to the upper surface.

8. A back plate comprising mounting holes for being passed through by the clamping hooks of support structures as claimed in claim 1 and locking holes for engaging the protrusions.

9. The back plate as claimed in claim 8, wherein the mounting holes are uniformly distributed on the back plate.

10. A direct-type backlight comprising a back plate and a diffusing plate which are oppositely arranged, and a plurality of support structures located between the back plate and the diffusing plate, wherein the support structures are support structures as claimed in claim 1, and the back plate comprises mounting holes for being passed through by the clamping hooks of the support structures and locking holes for engaging the protrusions.

11. The direct-type backlight as claimed in claim 10, wherein between the batten and the back plate is arranged a reflective sheet which is arranged in parallel to the lower surface, and the reflective sheet is provided with a mounting hole corresponding to the clamping hook.

12. The direct-type backlight as claimed in claim 10, wherein between the back plate and the diffusing plate further comprise a plurality of light sources, and the support structures do not coincide with the projections of the light sources in a direction perpendicular to the diffusing plate.

13. A display device comprising a direct-type backlight as claimed in claim 10.

14. The support structure as claimed in claim 2, wherein the support column comprises a main support column and an auxiliary support column, and height of the main support column is greater than that of the auxiliary support column in a direction perpendicular to the upper surface.

15. The support structure as claimed in claim 3, wherein the support column comprises a main support column and an auxiliary support column, and height of the main support column is greater than that of the auxiliary support column in a direction perpendicular to the upper surface.

16. The support structure as claimed in claim 4, wherein the support column comprises a main support column and an auxiliary support column, and height of the main support column is greater than that of the auxiliary support column in a direction perpendicular to the upper surface.

17. The support structure as claimed in claim 5, wherein the support column comprises a main support column and an auxiliary support column, and height of the main support column is greater than that of the auxiliary support column in a direction perpendicular to the upper surface.

18. The support structure as claimed in claim 6, wherein the support column comprises a main support column and an auxiliary support column, and height of the main support column is greater than that of the auxiliary support column in a direction perpendicular to the upper surface.
